(19) United States
(12) Patent Application Publication
(10) Pub. No.: US 2016/0017228 A1
(43) Pub. Date: Jan. 21, 2016

(54) LIQUID-CRYSTAL FILM

(71) Applicant: NATIONAL TAIWAN UNIVERSITY, Taipei City (TW)

(72) Inventors: Chih-Yu CHAO, TAIPEI CITY (TW); Jun-Wei CHEN, TAIPEI CITY (TW); Chiu-Chang HUANG, TAIPEI CITY (TW)

(21) Appl. No.: 14/582,656

(22) Filed: Dec. 24, 2014

(30) Foreign Application Priority Data
Jul. 21, 2014 (TW) 103125005

(51) Int. Cl. C09K 19/54; C08L 81/02

(52) U.S. Cl. CPC C09K 19/542; C08L 81/02; C09K 2019/526

(57) ABSTRACT

A liquid-crystal film includes a liquid crystal mixture with the gel state. The liquid crystal mixture is formed of at least one π-conjugated polymer gelator and a liquid-crystal unit. The concentration of the at least one π-conjugated polymer gelator is 0.05-5 wt %. The concentration of the liquid-crystal unit is 95-99.95 wt %. The at least one π-conjugated polymer gelator is aligned through the liquid-crystal unit and combined together to form a plurality of fibers. The fibers include at least 60% arranged regularly in direction and some of the fibers are linked with one another to form a network structure.

### BACKGROUND OF THE INVENTION

1. Field of the Invention

The present invention relates generally to a mixture of gelators and liquid crystals and more particularly, to a liquid-crystal film.

2. Description of the Related Art

Liquid crystals can be applied to the display technology. For example, the common liquid-crystal display is formed of two transparent plates (e.g. glass) and liquid crystals filled between the two transparent plates for displaying images or frames. In the liquid-crystal display, a voltage is applied to change molecular arrangement thereof to further alter optical transmission for display of the images or frames.

Nowadays, low-molecular-weight gelators have been available for mixture into the liquid crystals. Polymerized with irradiation of ultraviolet rays or by means of self-assembly, these low-molecular-weight gelators can be solidified and interconnected to form a network structure in the liquid crystals for some additional characteristics, e.g. shortening response time of liquid-crystal molecules or leading to scattering effect-after the liquid crystals are driven for alteration.

The mixture of the existing low-molecular-weight gelators and the nematic liquid crystals needs to be of 50-70 V before they are driven. However, such driving voltage is too high for the general electro-optical and electronic apparatus. If it is applied to the liquid-crystal display or masking film, the energy consumption will be in a higher level. Besides, the driving voltage of 50-70 V brings much inconvenience for the circuit designer because the circuit designer needs to consider the user's safety of electric shock and the life time of the electronic device resistant against high voltage.

Neither a mixture of gelators and liquid crystals having the aforesaid additional characteristics and lower driving voltage than that of the aforesaid mixture of the low-molecular-weight gelators and the nematic liquid crystals nor a mixture of gelators and liquid crystals having preferable characteristics than those of the aforesaid mixture of the low-molecular-weight gelators and the nematic liquid crystals has not been available yet.

### SUMMARY OF THE INVENTION

The primary objective of the present invention is to provide a liquid-crystal film having lower driving voltage.

The foregoing objective of the present invention is attained by the liquid-crystal film having a liquid-crystal mixture with the gel state. The liquid-crystal mixture is formed of at least one π-conjugated polymer gelator and a liquid-crystal unit. The concentration of the at least one π-conjugated polymer gelator is 0.05-5 wt %. The concentration of the liquid-crystal unit is 95-99.95 wt %. The at least one π-conjugated polymer gelator forms a plurality of fibers in the liquid-crystal unit. At least 60% of the fibers are arranged regularly in direction and some of the fibers are linked with one another to form a network structure.

Electron propagation is characteristic of the at least one π-conjugated polymer gelator to make the fibers characterized by the electron propagation. Further, the fibers in the liquid-crystal unit are mostly arranged regularly and some of the fibers form the network structure. Thus, the driving voltage of the liquid-crystal mixture can be effectively reduced as a whole to be lower than that of the mixture of the low-molecular-weight gelators and the liquid-crystal unit. Elastic energy is generated between the π-conjugated polymer gelator and the liquid-crystal molecules to shorten the response time of the liquid-crystal molecules when they are driven.

In addition, the present invention further provides a masking film formed of two said liquid-crystal films superposed on each other. A predetermined included angle is defined between the orientation of the regular arrangement of the fibers of one of said liquid-crystal films and the orientation of the regular arrangement of the fibers of the other liquid-crystal film.

Each of the driven liquid-crystal films can scatter the light. The scattering orientations of the two liquid-crystal films define the predetermined included angle therebetween, so the different scattering orientations make the scattering effect preferable to lead to effective masking effect.

In addition, the present invention further provides a liquid-crystal mixture formed of a liquid-crystal unit of 95-99.95 wt % and a π-conjugated polymer gelator of 0.05-5 wt % for follow-up production of the aforesaid liquid-crystal mixture.

### BRIEF DESCRIPTION OF THE DRAWINGS

FIG. 1 is a perspective view of a preferred embodiment of the present invention.

FIG. 2 is an enlarged view of a part A indicated in FIG. 1, illustrating the arrangement of liquid-crystal molecules and fibers formed by combination of π-conjugated polymer gelators.

FIG. 3 is a schematic view of the preferred embodiment of the present invention, showing an image taken by an optical microscope.

FIG. 4 is another schematic view of the preferred embodiment of the present invention, showing isotropic arrangement of the π-conjugated polymer gelators.

FIG. 5 is another schematic view of the preferred embodiment of the present invention, showing oriented arrangement of the liquid crystals.

FIG. 6 is another schematic view of the preferred embodiment of the present invention, showing arrangement of composition of the fibers.

FIG. 7 is another schematic view of the preferred embodiment of the present invention, showing the operational status of oriented means serving as an orientation film.

FIG. 8 is another schematic view of the preferred embodiment of the present invention, showing another image taken by the optical microscope.

FIG. 9 is another perspective view of an example in accordance with the preferred embodiment of the present invention.

FIG. 10 is a perspective view of another example in accordance with the preferred embodiment of the present invention.

FIG. 11 is a perspective view of another example in accordance with the preferred embodiment of the present invention.

FIG. 12 is a perspective view of another example in accordance with the preferred embodiment of the present invention.

### DETAILED DESCRIPTION OF PREFERRED EMBODIMENTS

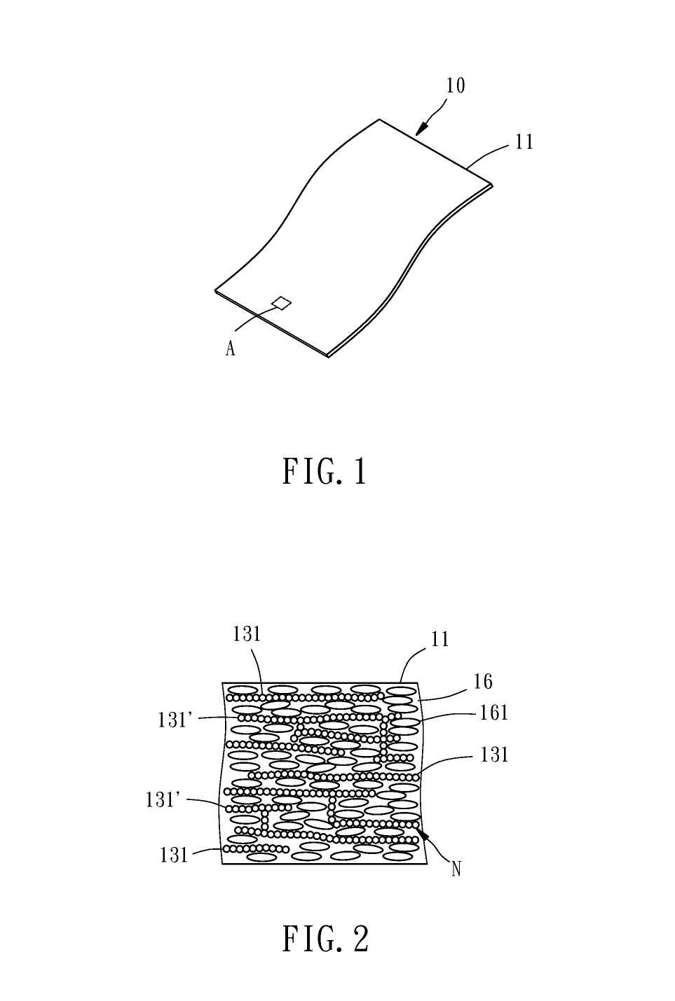

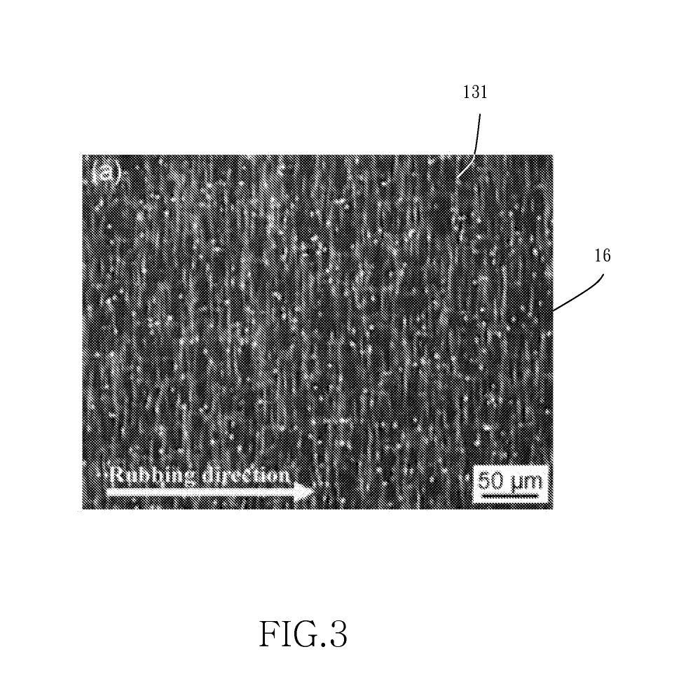

Referring to FIGS. 1-3, a liquid-crystal film 10 constructed according to a preferred embodiment of the present invention includes a liquid-crystal mixture 11 with the gel state. The liquid-crystal mixture 11 is formed of at least one π-conjugated polymer gelator 13 and a liquid-crystal unit 16. The concentration of the at least one π-conjugated polymer gelator 13 is 0.05-5 wt %. The concentration of the liquid-crystal unit 16 is 95-99.95 wt %. The at least one π-conjugated polymer gelator 13 is aligned through the liquid-crystal unit 16 and combined together to form a plurality of fibers 131. More than 60% of the fibers 131 are regularly arranged in a direction. Some of the fibers 131, being assigned with a reference numeral 131′, are linked with one another to make the whole fibers 131 become a network structure N. If the fibers 131 regularly arranged are less than 60% of the whole, the arrangement of the whole fibers 131 will tend to disorder and fail to effectively present the effect of electron mobility between the fibers 131. The effect of electron mobility will be recited hereinafter. FIG. 2 is an enlarged view of the portion A indicated in FIG. 1. For better understanding, liquid-crystal molecules 161 of the liquid-crystal unit 16 and the π-conjugated polymer gelator 13 are not proportionally arranged as shown in FIG. 2. FIG. 3 is a photo taken by an optical microscope, showing arrangement of fibers 131. As shown in FIG. 3, most (over 90%) of the fibers 131 are regularly arranged in direction.

In practice, the liquid-crystal unit 16 is formed of nematic liquid crystals, smectic liquid crystals, cholesteric liquid crystals, or a mixture of two or three of the aforesaid liquid crystals. In this preferred embodiment, the liquid-crystal unit 16 is formed of but not limited to nematic liquid crystals E7 as an example as shown in FIG. 3. The liquid-crystal unit 16 can be formed of nematic liquid crystals 5CB.

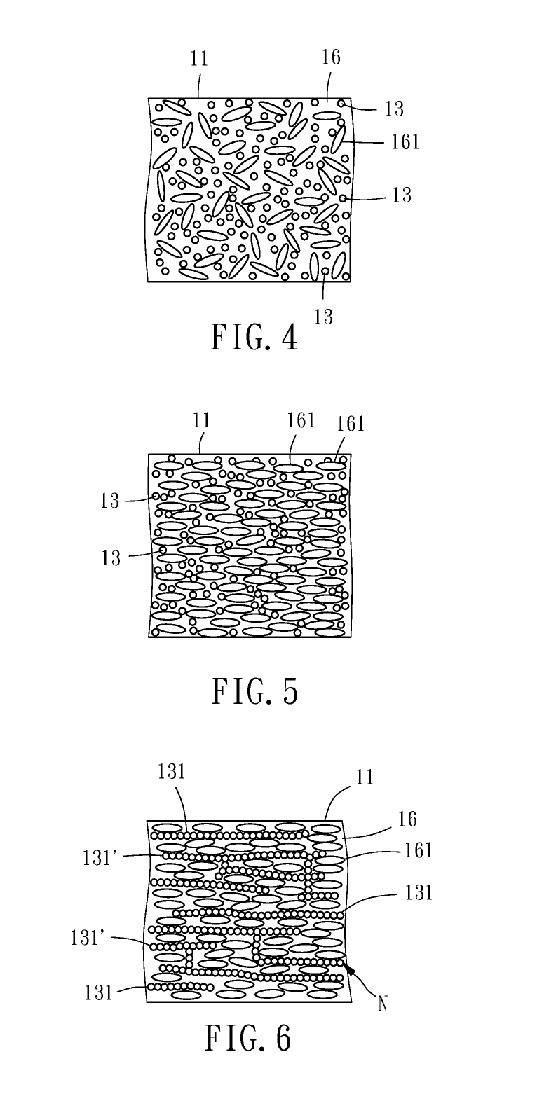

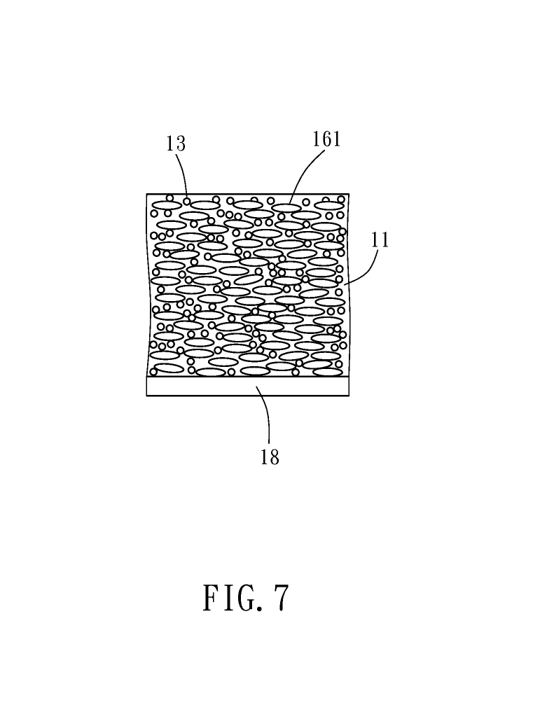

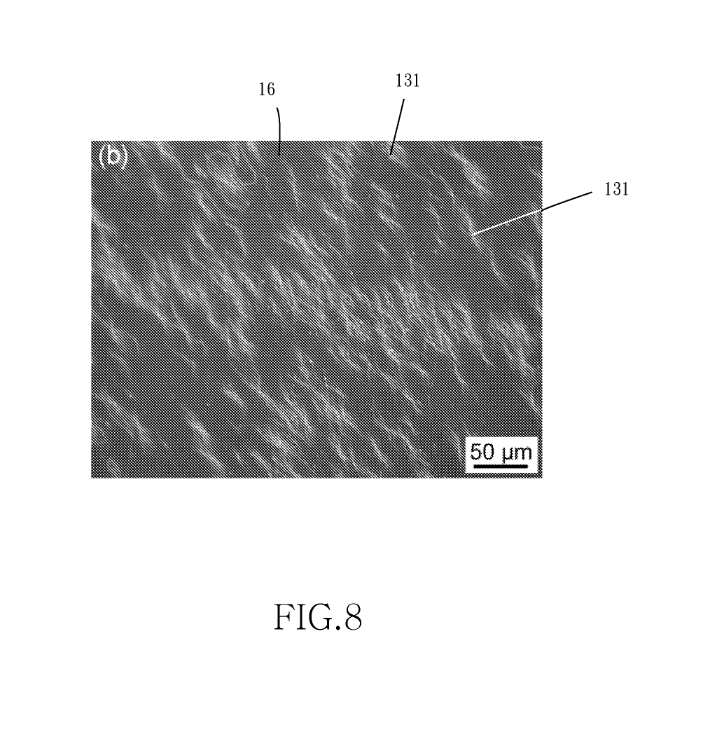

In the process of formation, the liquid-crystal mixture 11 are processed by a heating-up procedure and a cooling-down procedure to form the fibers 131. Referring to FIG. 4, the heating-up procedure is to heat the liquid-crystal mixture 11 for making the distribution of the π-conjugated polymer gelator 13 isotropic. Before the cooling-down procedure starts up, as shown in FIG. 5, an oriented means is used to make the arrangement of the liquid-crystal molecules 161 regularly aligned. Next, as shown in FIG. 6, the cooling-down procedure (e.g. natural cooling) is performed to cool down the liquid-crystal mixture 11. In the process of the cooling-down procedure, the π-conjugated polymer gelator 13 can be self-assembled. In the process of the self-assembly of the π-conjugated polymer gelator 13, subject to the arrangement of the liquid-crystal molecules 161, the fibers 131 and the network structure N are formed to further make the arrangement of the fibers 131 and the network structure N regular in direction as presented in FIG. 3. In practice, the oriented means indicates an orientation film or an electric field or both. When the orientation means is an orientation film 18, as shown in FIG. 7, the orientation film is attached to one side of the liquid-crystal mixture 11. When the orientation means is an electric field (not shown), the electric field is applied to the liquid-crystal unit 16 to make the liquid-crystal molecules 161 tend to oriented arrangement. Further, the aforesaid regular arrangement is variable subject to whether the fibers 131 is linear or curved. For example, when the alignment manner is antiparallel oriented, the fibers 131 are structurally subjected to the arrangement of the liquid-crystal molecules 161 after being formed; meanwhile, the fibers 131 are linear under the circumstances shown in FIG. 3, so the aforesaid regular arrangement is parallel. When the liquid-crystal unit 16 is twisted nematic liquid crystals 5CB, which are formed of but not limited to nematic liquid crystals 5CB as an example, the fibers 131 are S-shaped or the like after being formed as shown in FIG. 8. In terms of one of the fibers 131, the fiber can be regarded as the one having a central axis as a whole. The fibers 131 are regularly arranged in direction in a way that the central axes are arranged in parallel.

In the preferred embodiment, the at least one π-conjugated polymer gelator 13 is one in number as an example and can be poly(9,9-dioctylfluorene-alt-benzothiadiazole) (F8BT) of polyfluorene-based π-conjugated polymer gelator. The concentration of the π-conjugated polymer gelator 13, which is F8BT as an example, has a correlation with the driving voltage of the liquid-crystal mixture 11 containing F8BT and the liquid-crystal unit 16, which is E7 as an example. The correlation between the concentration of the π-conjugated polymer gelator 13 and the driving voltage of the liquid-crystal mixture 11 is shown in the following Table 1.

TABLE 1

| Concentration of π-conjugated | |
|---|---|
| Polymer Gelator 13 (% wt) | Driving Voltage (V) |
| 0.2 | 3.5 |
| 0.4 | 3.8 |
| 0.6 | 4.2 |
| 1 | 5.3 |
| 2 | 9.8 |
| 3 | 16.8 |
| 5 | 38.3 |

As known from the Table 1, when the concentration of the π-conjugated polymer gelator 13 is 0.2 wt %, the driving voltage is 3.5V that is much lower than that of the liquid-crystal mixture formed of the conventional low-molecular-weight gelators and liquid crystals. Even through the concentration of the π-conjugated polymer gelator 13 is increased to 5 wt %, the driving voltage, which is 38.3V, is still lower than that of the liquid-crystal mixture formed of the conventional low-molecular-weight gelators and liquid crystals.

In addition, the π-conjugated polymer gelator 13 can be mixed with either of other liquid crystals, such as twisted nematic liquid crystals 5CB, the correlation between the concentration and driving voltage is also available. The following Table 2 illustrates the relationship between the concentration and the driving voltage of the π-conjugated polymer gelator 13 (F8BT) and the liquid crystal (5CB) after they are mixed.

TABLE 2

| π-conjugated polymer | |
|---|---|
| gelator (% wt) | Driving Voltage (V) |
| 0 | 1.58 |
| 0.05 | 1.56 |
| 0.1 | 1.43 |
| 0.2 | 1.35 |
| 0.4 | 1.28 |

As known from the Table 2, when the liquid crystal is 5CB, even if the concentration of the π-conjugated polymer gelator 13 is 0.05 wt %, the driving voltage of the liquid-crystal mixture 11 can be effectively reduced. When the concentration is 0.4 wt % which is higher, the driving voltage can be much lower.

The average molecular weight of the at least one π-conjugated polymer gelator 13 is 5,000-65,000 Mn. In this preferred embodiment, the at least one π-conjugated polymer gelator 13 is one in number as an example to be F8BT and the average molecular weight of F8BT is 5,000-15,000 Mn. The fibers 131 shown in FIG. 3 are formed of the aforesaid π-conjugated polymer gelators 13 (F8BT). The average molecular weight of the aforesaid π-conjugated polymer gelator 13 has a correlation with the dissolubility of the π-conjugated polymer gelator 13 in the liquid-crystal unit 16. When the average molecular weight reaches 65,000 Mn and more, the π-conjugated polymer gelator 13 is hardly dissolved in the liquid-crystal unit 16. When the average molecular weight is less than 65,000 Mn, a part of the π-conjugated polymer gelator 13 can be dissolved into the liquid-crystal unit 16. The less the average molecular weight is, the higher the dissolubility is. When the average molecular weight is less than 50,000 Mn, the π-conjugated polymer gelator 13 can be almost dissolved in the liquid-crystal unit 16. However, among a variety of the π-conjugated polymer gelators 13, few have the average molecular weight that is less than 5,000 Mn. In light of the aforesaid concentrations, either of various kinds of the π-conjugated polymer gelators 13 having the average molecular weight of 5,000-65,000 Mn is acceptable. In addition, the aforesaid π-conjugated polymer gelator 13 is though F8BT but not limited to such π-conjugated polymer gelator and other π-conjugated polymer gelator like Poly[(9,9-dioctylfluorenyl-2,7-diyl)-co-bithiophene] (F8T2) or Poly(3-hexylthiophene-2,5-diyl) (P3HT) is also applicable. The average molecular weight of F8T2 is 15,000-25,000 Mn. The average molecular weight of P3HT is 50,000-70,000 Mn. In this preferred embodiment, there is only one of various kinds of the π-conjugated polymer gelators 13 as an example. However, in practice, the mixture of two or multiple kinds of the π-conjugated polymer gelators 13 with the liquid-crystal unit 16 are feasible as long as the concentration of the π-conjugated polymer gelator 13 conforms to the aforesaid weight percentage.

As the concentration of the at least π-conjugated polymer gelator 13 is higher, an interval between two adjacent fibers 131 is smaller. The average interval between two adjacent noncontact fibers 131 is 3-350 μm and has a correlation with the concentration of the π-conjugated polymer gelator 13. The following Table 3 illustrates the correlation between the concentration based on the nematic liquid crystal E7 and the π-conjugated polymer gelator 13 and the average interval defined between two adjacent noncontact fibers 131.

TABLE 3

| π-conjugated Polymer | |
|---|---|
| Gelator (% wt) | Average Interval (μm) |
| 0.05 | 344.8 |
| 0.1 | 140.3 |
| 0.2 | 57.1 |
| 0.4 | 23.2 |
| 0.6 | 13.7 |
| 1 | 8.1 |
| 2 | 5 |
| 3 | 3.7 |
| 4 | 3.2 |
| 5 | 3.0 |

Please note that the aforesaid Table 3 illustrates the correlation between the concentration of a specific π-conjugated polymer gelator 13 and the average interval of the fibers 131. The mixtures 11 formed of different kinds of the liquid-crystal units 16 and different kinds of the π-conjugated polymer gelators 13 lead to different correlations between the concentrations and the average intervals, respectively.

As for the fibers 131 of which the aforesaid network structure N is formed, due to the basis constructed by the π-conjugated polymer gelator 13 and the electrical conductivity of the π-conjugated polymer gelator 13, the electron mobility of the fibers 131 therebetween is higher than that of the liquid-crystal unit 16 when the network structure N has not been formed. In this way, the driving voltage of the whole liquid-crystal mixture 11 can be reduced; namely, the driving voltage of the liquid-crystal mixture 11 is lower than that of the conventional liquid-crystal mixture formed of the low-molecular-weight gelator and the liquid crystals. As known from the Table 1 and Table 2, after the nematic liquid crystals and the π-conjugated polymer gelator 13 of the liquid-crystal mixture 11 of the present invention are mixed with each other according to a predetermined proportion, the liquid-crystal mixture 11 only needs 2-4 V to be driven, so the driving voltage of the liquid-crystal mixture 11 is much lower than that (50-70 V) of the conventional one. Therefore, the present invention indeed greatly improves the drawback that the prior art needs high driving voltage.

The fibers 131 formed by the π-conjugated polymer gelator 13 are not irradiated by ultraviolet rays for solidification but self-assembled via the heating-up and cooling-down procedures. Elastic energy generated between the liquid-crystal molecules 161 and the fibers 131 makes the liquid-crystal molecules be hauled by the fibers 131, after the driving voltage disappears, to quickly return to the original arrangement, so the response time can be shortened.

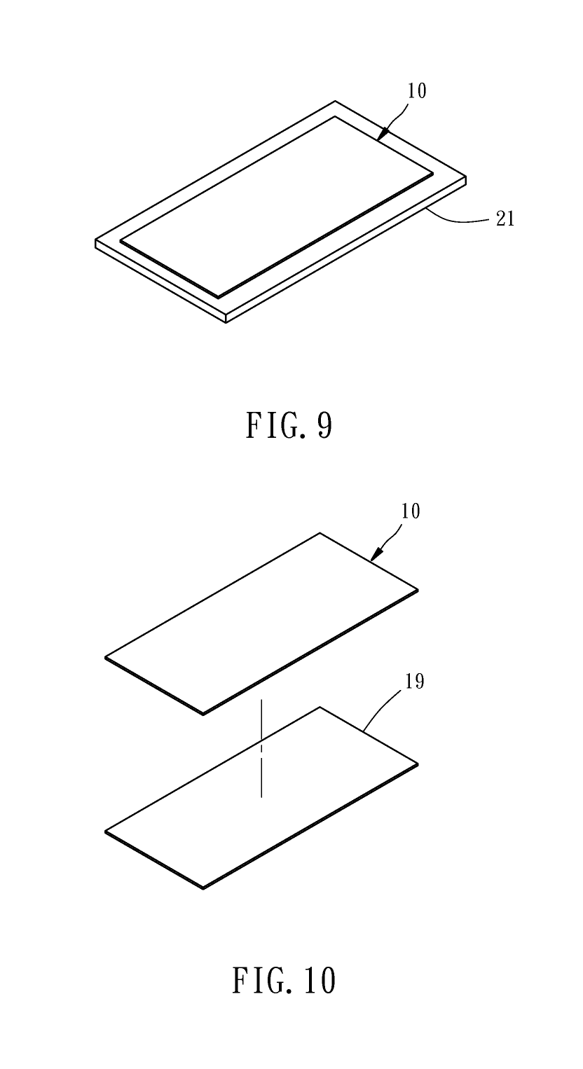

Referring to FIG. 9, the liquid-crystal film 10 of this preferred embodiment of the present invention can be mounted to a first transparent substrate 21 and covers at least one part of the first transparent substrate 21. The first transparent substrate 21 is made of glass or a flexible plastic film. In this way, the first transparent substrate 21 and the liquid-crystal film 10 jointly constitute a semi-product. When the liquid-crystal film 10 is driven alone, the liquid-crystal molecules 161 shown in FIG. 2 can be arranged to scatter the light, so the liquid-crystal film 10 can be applied to scattering glass or a masking glass. When the liquid-crystal film 10 is applied to scattering glass or a masking glass, the liquid-crystal unit 16 characterized by a bistable feature can be adopted, so after the liquid-crystal unit 16 is driven, the liquid crystals in the liquid-crystal unit 16 can keep a predetermined direction without being provided with continuous driving voltage, thus leading to energy saving.

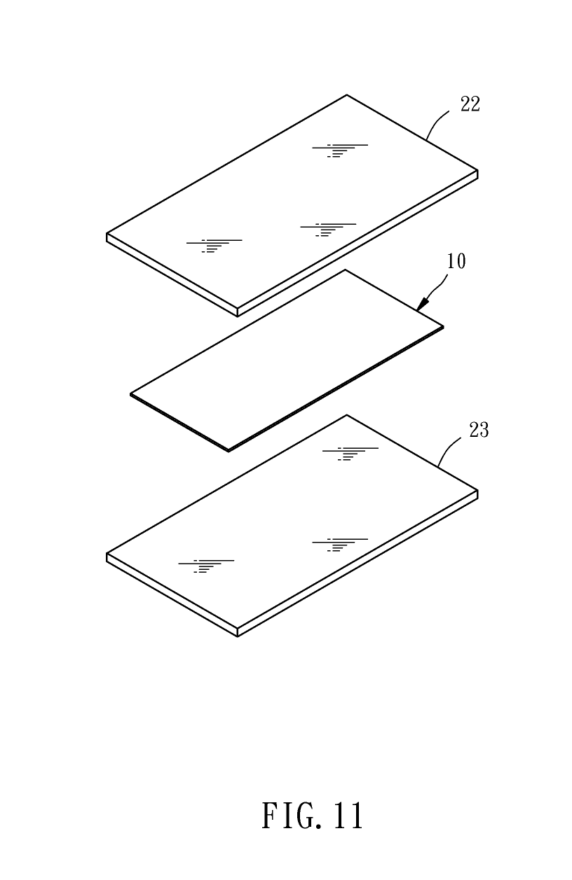

Referring to FIG. 10, the liquid-crystal film 10 can be mounted to a polarizer 19 and such structure can be applied to a liquid-crystal display (not shown). In practice, the polarizer 19 and the liquid-crystal film 10 can be further jointly mounted to a transparent substrate (not shown) or between two transparent substrates for application to the liquid-crystal display.

Referring to FIG. 11, the liquid-crystal film 10 can also be mounted between a second transparent substrate 22 and a third transparent substrate 23. The application of such structure is similar to what is indicated in FIG. 9 to be applicable to scattering glass or a masking glass. In addition, one additional polarizer 19 shown in FIG. 10 can be further applied to a liquid-crystal display (not shown). Such application is understandable by referring to FIG. 10, so no more drawings are necessary.

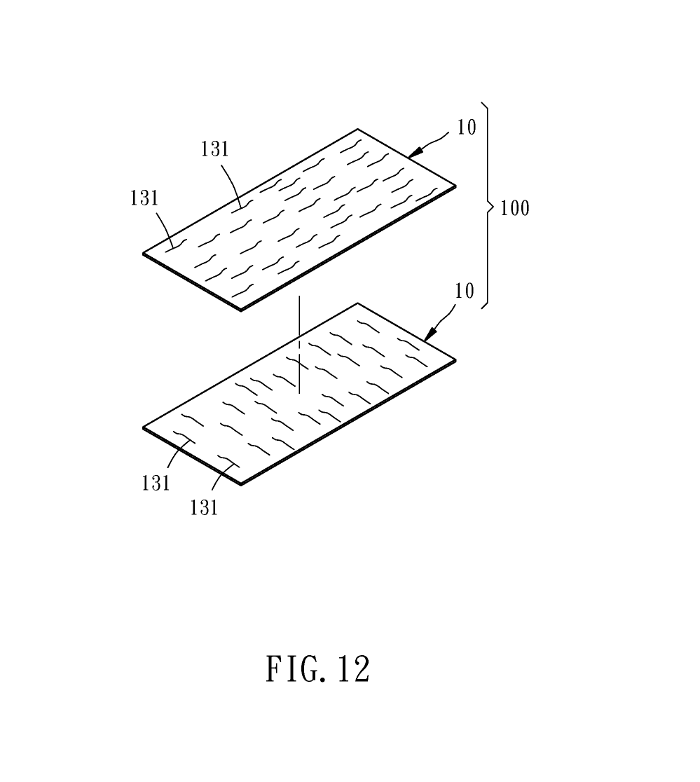

Referring to FIG. 12, the liquid-crystal film 10 of the present invention can also be applied to others. For example, two of the liquid-crystal films 10 are superposed on each other and the orientation of the regular arrangement of the fibers 131 of one of the liquid-crystal films 10 defines a predetermined included angle with the orientation of the regular arrangement of the fibers 131 of the other liquid-crystal film 10, so a masking film 100 is formed. When the liquid-crystal films 10 are driven to scatter the light, scattering orientations of the two liquid-crystal films 10 define the predetermined included angle therebetween to make the scattering effect greater. The predetermined included angle is 0-90 degrees and is preferably 90 degrees. Even if the predetermined included angle is 0, the masking film 100 can also be formed because the two liquid-crystal films 10 can still scatter the light after they are driven; however, the scattering effect is not as great as the predetermined included angle is 90 degrees. It is worth mentioning that the two superposed liquid-crystal films 10 can also be further mounted to a fourth transparent substrate (not shown) for convenient installation or transportation (no more drawings are necessary because this mounting manner is identical to what is indicated in FIG. 9); or the two superposed liquid-crystal films 10 can be mounted to two sides of the fourth transparent substrate to be superposed on each other with the fourth transparent substrate located between the two liquid-crystal films 10 (no more drawings are necessary because this mounting manner is easily understandable). In addition, it is understandable that the two liquid-crystal films 10 can also be mounted to a transparent substrate (not shown), before they are superposed on each other, the same effect of the aforesaid masking film can be attained.

It is to be further clarified that an additional nanomaterial, liquid solvent, dye, or chiral dopant (not shown) of predetermined weight can be mixed into the liquid-crystal mixture 11. When the nanomaterial, the liquid solvent, the dye, or the chiral dopant is doped into the liquid-crystal mixture 11, the nanomaterial, liquid solvent, dye, or chiral dopant is in an amount of 0.01-5 parts by weight based on 100 parts by weight of the liquid-crystal unit 16. Such doping can though alter the proportion of the π-conjugated polymer gelator 13 to the whole liquid-crystal mixture 11, but the ratio of the parts by weight of the π-conjugated polymer gelator 13 to the liquid-crystal unit 16 is still not changed. The doping of the nanomaterial, the liquid solvent, the dye, or the chiral dopant of proper concentration can make the liquid-crystal mixture have different characteristics. When the nanomaterial or the liquid solvent doped into the liquid-crystal mixture 11 reaches an appropriate concentration, the electron mobility of the fibers 131 of the liquid-crystal film 10 can be auxiliarily increased to further make the driving voltage of the liquid-crystal film 10 lower. The dye can make the liquid-crystal film 10 colored. The chiral dopant can make the liquid-crystal unit 16 structurally chiral.

In light of the above, the fibers 131 are formed of the π-conjugated polymer gelator 13 in the liquid-crystal film 10. The π-conjugated polymer gelator 13 can conduct electrons, so the driving voltage of the liquid-crystal film 10 is much lower than that of the conventional liquid-crystal mixture formed of the low-molecular-weight gelator and the liquid-crystal unit. In addition, the elastic energy generated between the liquid-crystal molecules 161 and the fibers 131 formed of the π-conjugated polymer gelator 13 can be generated to shorten the response time of the driven liquid-crystal molecules 161, thus being applicable to an electro-optical switch.

The aforesaid liquid-crystal mixture 11 of the present invention is formed of the liquid-crystal unit of 95-99.95 wt % and the π-conjugated polymer gelator 13 of 0.05-5 wt %. The π-conjugated polymer gelator 13 is F8BT, F8T2, or P3HT but not limited to either of them. The liquid crystals adopted in the liquid-crystal mixture 11 is not limited to either of any types and can be applied to the nematic liquid crystal E7 or 5CB as previously exemplified and to different driving modes, such as liquid-crystal modes of antiparallel alignment and twisted nematic modes.

What is claimed is:

1. A liquid-crystal film comprising a liquid-crystal mixture with a gel state, the liquid-crystal mixture being formed of at least one π-conjugated polymer gelator and a liquid-crystal unit, the at least one π-conjugated polymer gelator having a concentration of 0.05-5 wt %, the liquid-crystal unit having a concentration of 95-99.95 wt %, the at least one π-conjugated polymer gelator being aligned through the liquid-crystal unit and combined together to form a plurality of fibers, the fibers having at least 60% arranged regularly in direction, some of the fibers being linked with one another to form a network structure.

2. The liquid-crystal film as defined in claim 1, wherein the at least one π-conjugated polymer gelator comprises an average molecular weight of 5,000-65,000 Mn.

3. The liquid-crystal film as defined in claim 1, wherein two adjacent noncontact fibers define an average interval of 3-350 μm therebetween.

4. The liquid-crystal film as defined in claim 1 further comprising a nanomaterial, a liquid solvent, a dye, or a chiral dopant in an amount of 0.01-5 parts by weight based on 100 parts by weight of the liquid-crystal unit.

5. The liquid-crystal film as defined in claim 1, wherein the liquid-crystal mixture is processed by a heating-up procedure and a cooling-down procedure, the at least one π-conjugated polymer gelator being self-assembled to form the fibers and the network structure in the process of the cooling-down procedure.

6. The liquid-crystal film as defined in claim 5, wherein before the cooling-down procedure begins, an oriented means is adopted to make regular arrangement of liquid-crystal molecules in the liquid-crystal unit, whereby when the at least one π-conjugated polymer gelator is self-assembled, the at least one π-conjugated polymer gelator is subject to the arrangement of the liquid-crystal molecules to be regularly arranged in direction.

7. The liquid-crystal film as defined in claim 6, wherein the oriented means indicates an orientation film or an electric field or both.

8. The liquid-crystal film as defined in claim 1, wherein the fibers are linear or curved; when the fibers are linear, the fibers are parallel to one another to present the regular arrangement; when the fibers are curved, central axes of the fibers are parallel to one another to present the regular arrangement.

9. The liquid-crystal film as defined in claim 1, wherein the liquid-crystal film is mounted to a side of a first transparent substrate and covers at least one part of the first transparent substrate.

10. The liquid-crystal film as defined in claim 1, wherein the liquid-crystal film is further mounted to a side of a polarizer.

11. The liquid-crystal film as defined in claim 1, wherein the liquid-crystal film is mounted between a second transparent substrate and a third transparent substrate.

12. A masking film comprising:
two of the liquid-crystal films defined in claim 1;
wherein the two liquid-crystal films are superposed on each other and the orientation of the regular arrangement of the fibers of one of the liquid-crystal films defines a predetermined included angle with that of the regular arrangement of the fibers of the other liquid-crystal film.

13. The masking film as defined in claim 12, wherein the predetermined included angle is 0-90 degrees.

14. The masking film as defined in claim 12 further comprising a fourth transparent substrate, wherein the two superposed liquid-crystal films are mounted to the fourth transparent substrate or the two liquid-crystal films are mounted to two sides of the fourth transparent substrate, respectively, as the fourth transparent substrate is located between the two liquid-crystal films.

15. A liquid-crystal mixture comprising a liquid-crystal unit of 95-99.95 wt % and at least one π-conjugated polymer gelator of 0.05-5 wt %.

16. The liquid-crystal mixture as defined in claim 15, wherein the at least one π-conjugated polymer gelator comprises an average molecular weight of 5,000-65,000 Mn.

17. The liquid-crystal mixture as defined in claim 15, wherein the at least one π-conjugated polymer gelator is polyfluorene-based π-conjugated polymer gelator.

18. The liquid-crystal mixture as defined in claim 17, wherein the at least one π-conjugated polymer gelator is poly(9,9-dioctylfluorene-alt-benzothiadiazole) (F8BT).

19. The liquid-crystal mixture as defined in claim 17, wherein the at least one π-conjugated polymer gelator is poly[(9,9-dioctylfluorenyl-2,7-diyl)-co-bithiophene] (F8T2).

20. The liquid-crystal mixture as defined in claim 17, wherein the at least one π-conjugated polymer gelator is poly(3-hexylthiophene-2,5-diyl) (P3HT).
